(19) United States
(12) Patent Application Publication
(10) Pub. No.: US 2008/0209949 A1
(43) Pub. Date: Sep. 4, 2008

(54) FORMING DEVICE FOR FORMING OPTICAL GLASSES

(76) Inventor: Meng-Kun Wang, Tan-Tzu Hsiang (TW)

Correspondence Address: TROP PRUNER & HU, PC, 1616 S. VOSS ROAD, SUITE 750, HOUSTON, TX, 77057-2631, US

(21) Appl. No.: 12/120,757

(22) Filed: May 15, 2008

Related U.S. Application Data
(63) Continuation-in-part of application No. 11/109,140, filed on Apr. 19, 2005.

(51) Int. Cl. C03B 11/08

(52) U.S. Cl. 65/307

(57) ABSTRACT

A forming device includes a sleeve member mountable between lower and upper mold units to hold a glass blank and having a stepped sleeve wall that defines first, second and third slot sections, and annular first and second shoulder faces. The second slot section is smaller than the third slot section and larger than the first slot section, and has top and bottom ends connected directly to the third and first slot sections. The first shoulder face extends radially at the junction of the first and second slot section to support the glass blank. A portion of the sleeve wall extends axially and upwardly from the first shoulder face to limit the glass blank from movement. The second shoulder face extends at the junction of the second and third slot sections to hold a lens formed from the glass blank.

### CROSS-REFERENCE TO RELATED APPLICATION

This application is a C-I-P application of U.S. patent application Ser. No. 11/109,140 which is filed on Apr. 19, 2005 and which claims priority from Taiwanese Invention Application No. 93122915 filed on Jul. 30, 2004.

### BACKGROUND OF THE INVENTION

1. Field of the Invention

This invention relates to a forming device, more particularly to a forming device for forming optical glasses.

2. Description of the Related Art

Referring to FIGS. 1 and 2, there is shown a conventional forming device for forming a glass blank into a lens. The forming device includes a sleeve member 1, a lower molding core 2 connected to the sleeve member 1 for placement of a glass blank 4, and an upper molding core 3 insertable into the sleeve member above the lower molding core 2. After the glass blank 4 is placed on the lower molding core 2, the upper molding core 3 is lowered to press and form the glass blank 4 into a lens 5 at high temperature. When the upper molding core 3 is removed from the sleeve member 1, a suction nozzle 7 is inserted into the sleeve member 1, as shown in FIG. 3, to suck and transfer the lens 5 to a next processing station. When the forming device is used in a continuous forming process, the sleeve member 1 together with the lower and upper molding cores 2, 3 are moved in order to carry and transport the glass blank 4 from station to station.

A problem encountered with such a forming device is that, during the process of placing the glass blank 4 onto the lower molding core 2, or during the process of transporting the forming device, the glass blank 4 is susceptible of misalignment with the central axis of the sleeve member 1, thereby resulting in positional deviation with respect to the lower and upper molding cores 2, 3, as shown in FIG. 4. The positional deviation will lead to formation of defective lenses with asymmetric thickness, as shown in FIG. 5.

U.S. Pat. No. 6,698,241 discloses a parison mold for pressing a parison, such as a glass bottle. The parison mold includes parison mold halves, a neck mold, and a pressing plunger insertable into a cavity of the parison mold halves through a bottom through passage defined by the neck mold and extendable to a height higher than the through passage to press a gob of molten glass introduced into the cavity. The neck mold is used to press the gob so as to form a neck part of the bottle. After the bottle is formed, the neck mold is used to hold the neck and transfer the bottle to a finish-forming station. Since the bottle is formed from the molten glass rather than a glass blank, the patent suggests nothing relevant to centering of a glass blank with respect to a mold.

### SUMMARY OF THE INVENTION

An object of the present invention is to provide an improved forming device with a sleeve member which can be used to hold and center a glass blank with respect to the forming device.

Accordingly, the present invention provides a forming device for forming a glass blank into a lens. The forming device comprises: a lower mold unit having a first forming face; an upper mold unit including a second forming face above the first forming face; and a sleeve member adapted to carry the glass blank and the lens, and mountable detachably between the lower and upper mold units. The sleeve member has a stepped sleeve wall confining a slot. The slot includes a first slot section, a second slot section disposed above the first slot section and having a diameter larger than that of the first slot section, a third slot section disposed above the second slot section and having a diameter larger than that of the second slot section. The second slot section has top and bottom ends connected directly to the third and first slot sections. The stepped sleeve wall includes an annular first shoulder face extending substantially radially at a junction of the first and second slot sections and adapted to contact a bottom face of the glass blank, and an annular second shoulder face adapted to support the lens. The second shoulder face is larger in diameter than the first shoulder face and extends substantially radially above the first shoulder face. A portion of the stepped sleeve wall that surrounds the second slot section extends substantially axially and perpendicularly to the first shoulder face, and is adapted to contact and limit the glass blank from movement. When the sleeve member is mounted between the upper and lower mold units, the first forming face extends into the slot to a height higher than the second slot section so that the glass blank is unlimited by the portion of the sleeve wall.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a sectional view of a conventional forming device;

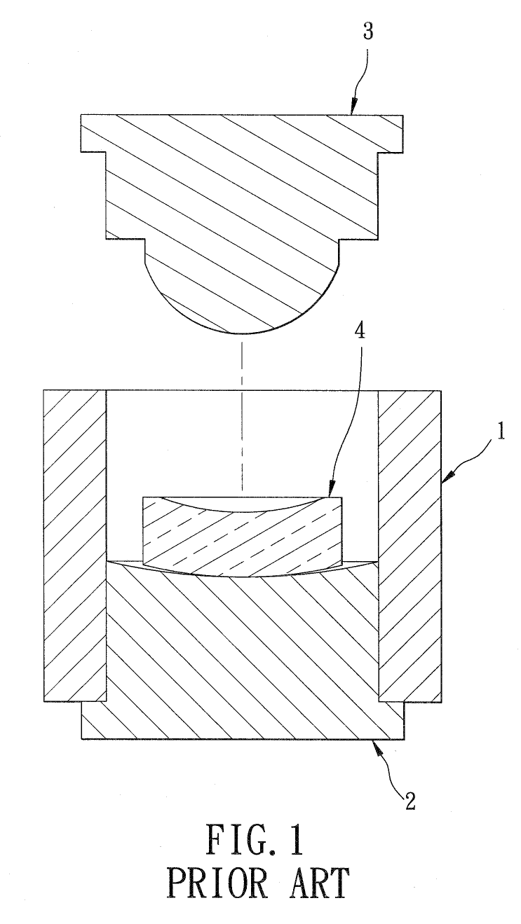

FIG. 2 is the same view as FIG. 1 but with an upper molding core being lowered;

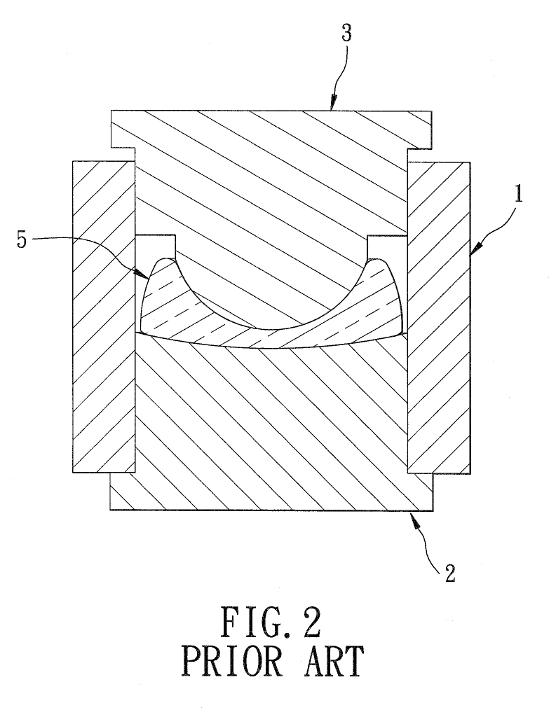

FIG. 3 is the same view as FIG. 1 but with the upper molding core being removed;

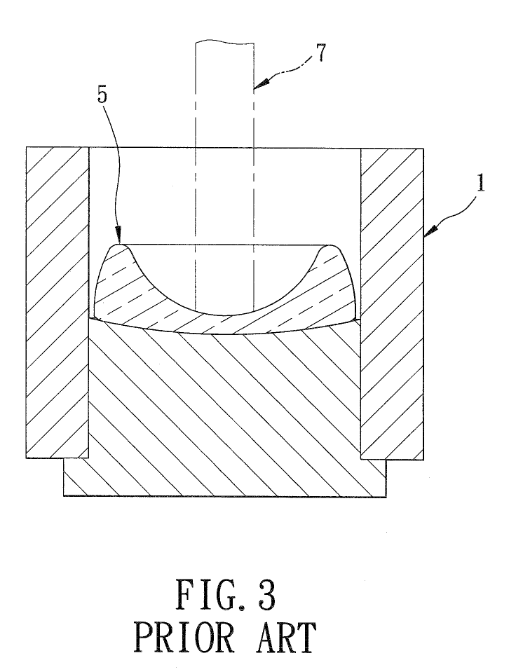

FIG. 4 is the same view as FIG. 1 but showing a misaligned glass blank;

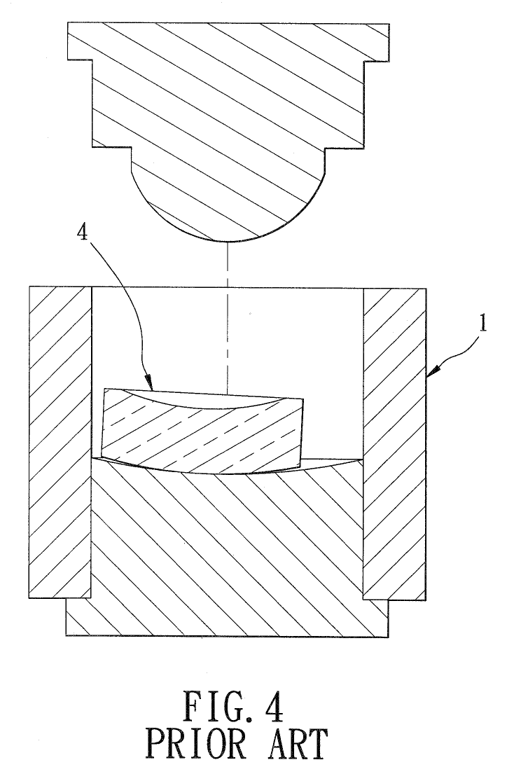

FIG. 5 is the same view as FIG. 1 but showing a deformed lens;

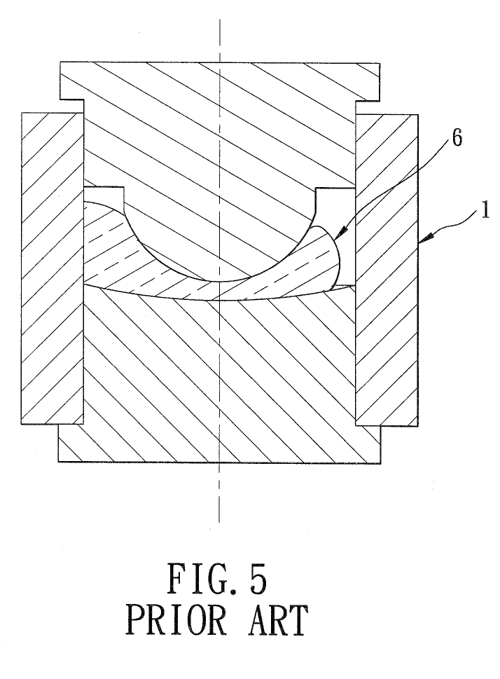

FIG. 6 is a sectional view of a first preferred embodiment of the present invention;

FIG. 7 is the same view as FIG. 6 but with a glass blank placed within a sleeve member;

FIG. 8 is the same view as FIG. 6 but with the sleeve member in abutment with upper and lower mold units;

FIG. 9 is the same view as FIG. 8 but with the glass blank being pressed by an upper molding core;

FIG. 10 is the same view as FIG. 9 but with the glass blank being formed into a lens;

FIG. 11 is a sectional view of the second preferred embodiment of the present invention;

FIG. 12 is a plan view of a sleeve member of the second preferred embodiment;

FIG. 13 is the same view as FIG. 11 but with the sleeve member in abutment with upper and lower mold units;

FIG. 14 is the same view as FIG. 11 but with glass blanks being formed into lenses; and

FIG. 15 is the same view as FIG. 12 but with the glass blanks being formed into lenses.

### DETAILED DESCRIPTION OF THE PREFERRED EMBODIMENTS

Before the present invention is described in greater detail, it should be noted that same reference numerals have been used to denote like elements throughout the specification.

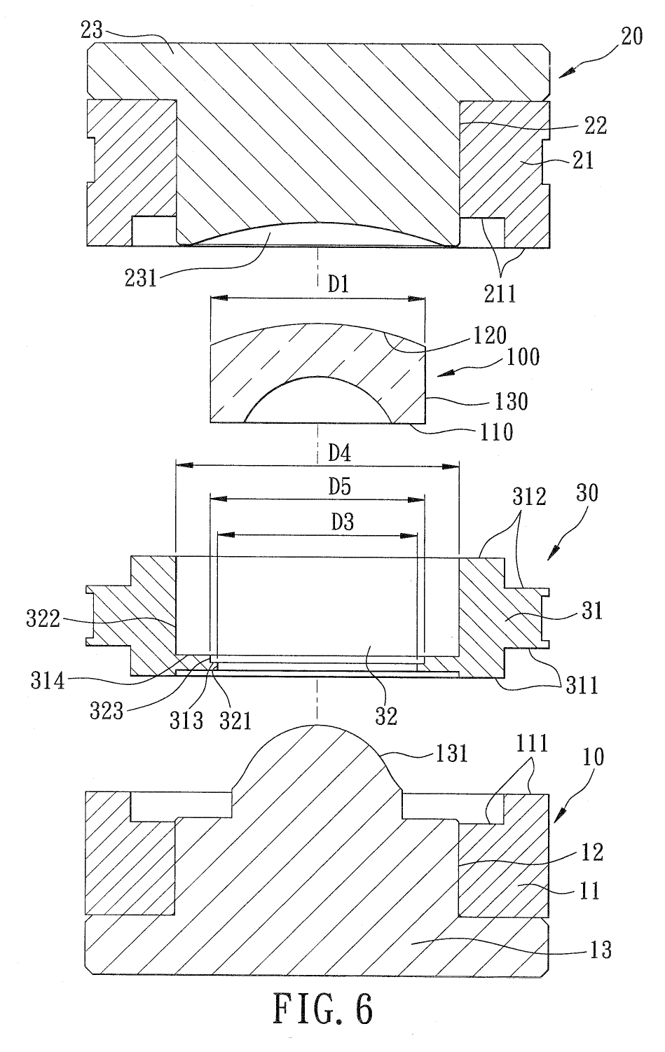

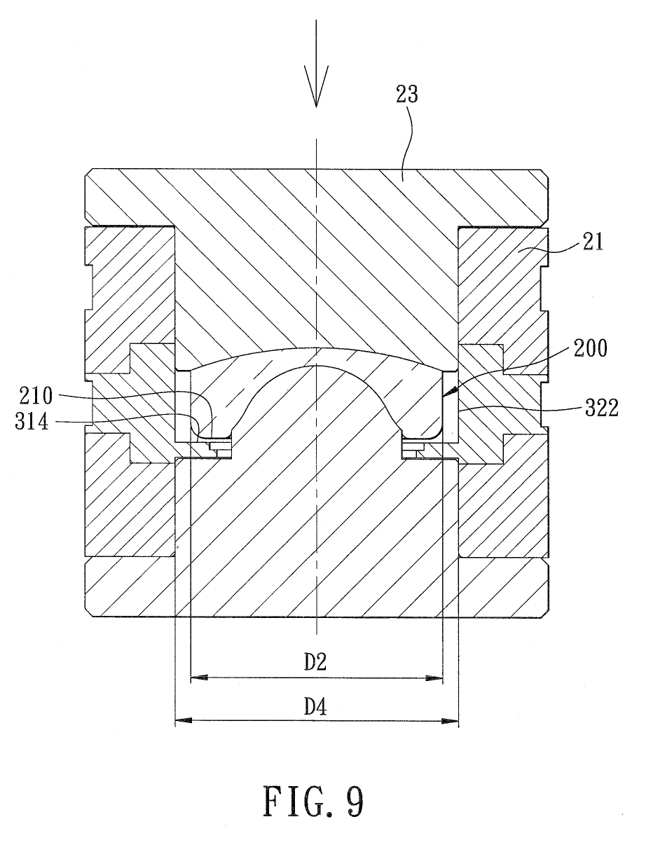

Referring to FIG. 6, there is shown a first preferred embodiment of the forming device according to the present invention for forming a glass blank 100 having with a small diameter (D1) into a lens 200 having a large diameter (D2) (see FIG. 9). The glass blank 100 has a bottom face 110, an opposite top face 120 and an outer peripheral end 130. The forming device includes a lower mold unit 10, an upper mold unit 20 and a sleeve member 30.

The lower mold unit 10 includes a lower socket member 11 defining a lower socket hole 12, and a lower molding core 13 inserted into the lower socket hole 12. The lower socket member 11 has a first abutment face 111, whereas the lower molding core 13 has a first forming face 131. In this embodiment, the first forming face 131 is provided on top of the lower molding core 13, whereas the first abutment face 111 is formed on top of the lower socket member 11 around the first forming face 131.

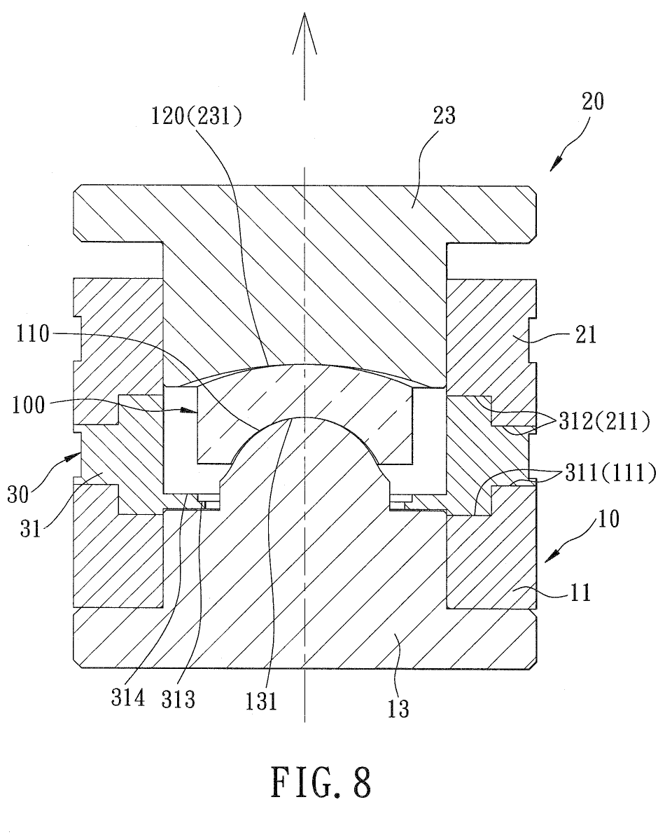

The upper mold unit 20 includes an upper socket member 21 defining an upper socket hole 22, and an upper molding core 23 inserted into the upper socket hole 22. The upper socket member 21 has a second abutment face 211, whereas the upper molding core 23 has a second forming face 231 facing the first forming face 131. In this embodiment, the second abutment face 211 is formed on the bottom end of the upper socket member 21 to face the lower molding core 13 and the second forming face 231 is formed on the bottom end of the upper molding core 23 to face the lower mold unit 10. The upper molding core 23 is movable relative to the upper socket member 21 to displace between a first position which is away from the lower molding core 13 (see FIG. 8) and a second position which is close to the lower molding core 13 (see FIG. 9).

The sleeve member 30 is mountable removably between the upper and lower mold units 20, 10. The sleeve member 30 includes a stepped sleeve wall 31 defining a slot 32. The slot 32 has a first slot section 321 having a diameter (D3) smaller than an outer diameter (D1) of the glass blank 100, a second slot section 323 connected to the first slot sections 321 and having a diameter (D5) substantially equal to the diameter D1 of the glass blank 100, and a third slot section 322 which has a diameter (D4) larger than an outer diameter (D2) of the lens 200.

In addition, the second slot section 323 is disposed above the first slot section 321 and the diameter (D5) thereof is larger than the diameter (D3) of the first slot section 321. The third slot section 322 is disposed above the second slot section 323 and the diameter (D4) thereof is larger than the diameter (D5) of the second slot section 323. The second slot section 323 has bottom and top ends directly connected to the first and third slot sections 321 and 322.

The sleeve wall 31 has a third abutment face 311 to abut against the first abutment face 111, a fourth abutment face 312 to abut against the second abutment face 211, an annular first shoulder face 313 extending radially at a junction of the first and second slot sections 321, 323 to support the glass blank 100, and an annular second shoulder face 314 adapted to support the lens (see FIG. 9). The second shoulder face 314 is larger in diameter than the first shoulder face 313 and extends substantially radially above the first shoulder face 313. Preferably, the second shoulder face 314 extends radially at a junction of the third and second slot sections 322, 323.

The third and fourth abutment faces 311, 312 are formed respectively at bottom and top ends of the sleeve wall 31. A portion of the sleeve wall 31 that surrounds the second slot section 323 extends substantially axially and perpendicularly to the first shoulder face 313. Said portion of the sleeve wall 31 is adapted to contact the outer peripheral end 130 of the glass blank 100.

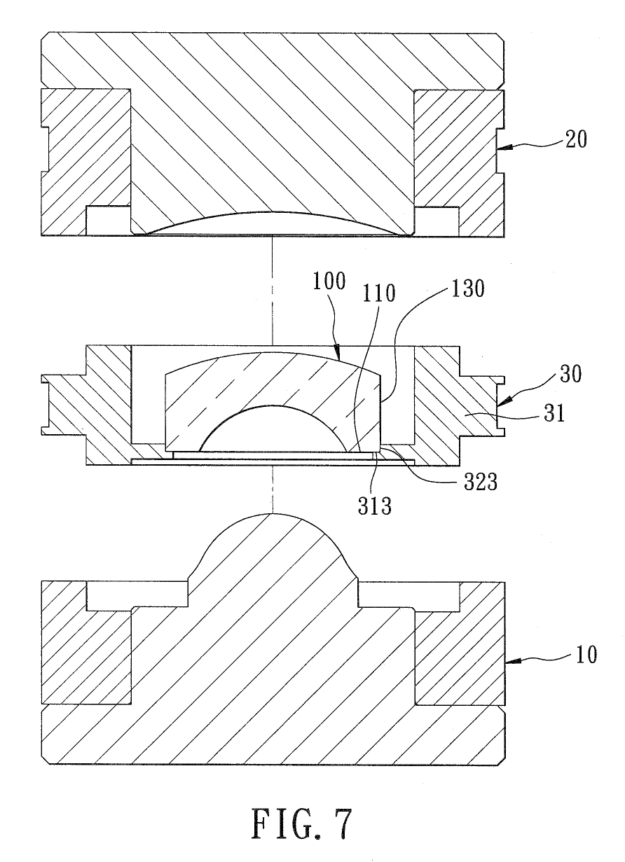

Referring to FIG. 7, when the glass blank 100 is placed on the first shoulder face 313, the portion of the sleeve wall 31 that surrounds the second slot section 323 contacts the outer peripheral end 130 of the glass blank 100 and limits the glass blank 100 from movement. The sleeve member 30, together with the glass blank 100, is disposed between the upper and lower mold units 20, 10 by using a robot arm (not shown) which carries the sleeve member 30.

Referring to FIG. 8, after the sleeve member 30 is mounted on the lower mold unit 10, the upper mold unit 20 is lowered and assembled with the sleeve member 30. At this state, the third and fourth abutment faces 311, 312 of the sleeve member 31 respectively abut against the first and second abutment faces 111 and 211 of the lower and upper socket members 11 and 21. Since, after assembly, the first forming face 131 of the lower molding core 13 is higher than the second shoulder face 314 of the sleeve wall 31, the glass blank 100 is lifted by the first forming face 131 from the first shoulder face 313 so that the top face 120 of the glass blank 100 pushes upward the upper molding core 23 to a first position as shown in FIG. 8. When the upper molding core 23 is moved downward from the first position to a second position as shown in FIG. 9, the glass blank 100 is pressed and formed into the lens 200. The outer peripheral end of the lens 200 extends to a level above and near the second shoulder face 314.

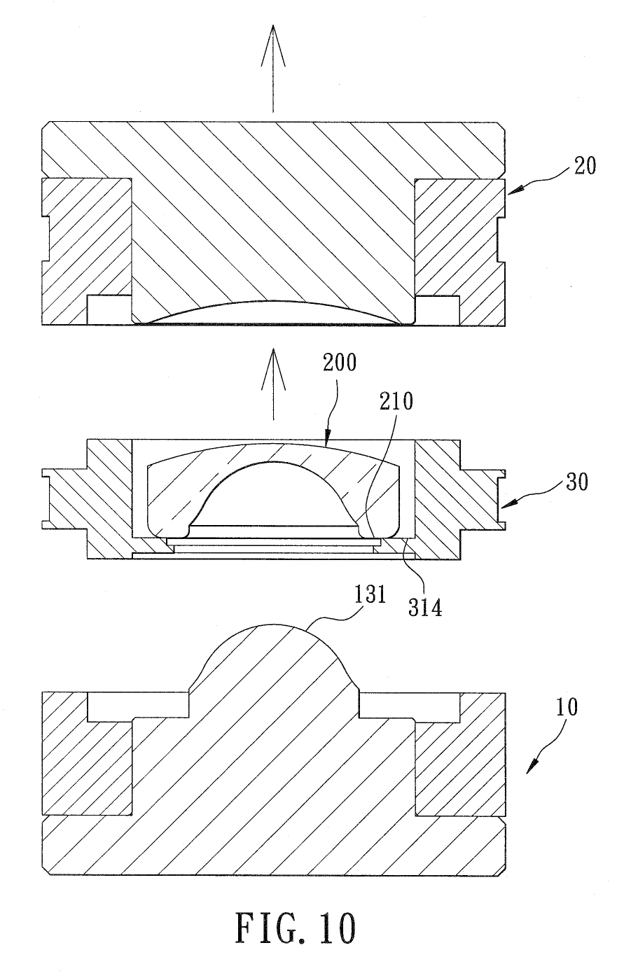

Referring to FIG. 10, the upper molding core 20 is moved upward to separate from the sleeve member 30, and the sleeve member 30 is moved upward to depart from the lower molding core 10. As the sleeve member 30 is moved upward from the lower molding core 10, the lens 200 is moved away from the first forming face 131, and the bottom face 210 of the lens 200 is in contact with the second shoulder face 314 of the sleeve wall 31. Therefore, the sleeve member 30 together with the lens 200 is removed from the lower and upper mold units 10 and 20, and the lens 200 may be carried by the sleeve member 30 for transport to a next processing station.

The advantages of the present invention are as follows:

1. Due to the use of the sleeve member 30, the forming device of the present invention does not require any suction nozzle to load the glass blank 100 onto the forming device and to unload the lens 200 from the forming device. The sleeve member 30 can hold and transport either the glass blank 100 or the lens 200 because of the presence of the radially extending first shoulder face 313 to support the glass blank 100, and the radially extending second shoulder face 314 to support the lens 200. The second should face 314 is larger in diameter and higher than the first shoulder face 313 to hold the lens 200 which is larger than the glass blank 100. The third slot section 322 is higher than and larger than the first and second slot sections 321, 323 to permit the glass blank 100 or the lens 200 to move out of the slot 32 through the third slot section 322.

2. When the glass blank 100 is placed on the first shoulder face 313 of the sleeve member 30, the outer peripheral end 130 of the glass blank 100 is bounded by the portion of the sleeve wall 31 that surrounds the second slot section 323 and that extends axially and perpendicularly to the first shoulder face 313 so that the glass blank 100 will not slip or run out of alignment with the center of the sleeve member 30. Therefore, when the sleeve member 30 and the glass blank 100 are assembled with the upper and lower mold units 20, 10, the glass blank 100 can be aligned automatically with the center of the upper and lower mold units 20, 10. As such, positional deviation of the glass blank 100 and formation of an asymmetric lens can be effectively prevented, thereby increasing the yield of good quality products.

3. As shown in FIG. 10, unlike the forming face of the lower molding core 2 in the prior art, the first forming face 131 of the lower mold unit 10 protrudes upward so that a concavity is formed in the bottom face of the lens 200 and a peripheral bottom end 210 surrounds the concavity formed in the bottom face. After the sleeve member 30 is removed from the lower and upper mold units 10, 20, only the peripheral bottom end 210 of the lens 200 is supported by the sleeve member 30. As a major portion of the lens 200 does not contact the sleeve member 30, when the lens is subjected to cooling, the use of the sleeve member 30 as a support for the lens 200 can alleviate the problem of stresses resulting from the difference between thermal expansion coefficients of the lens 200 and its support.

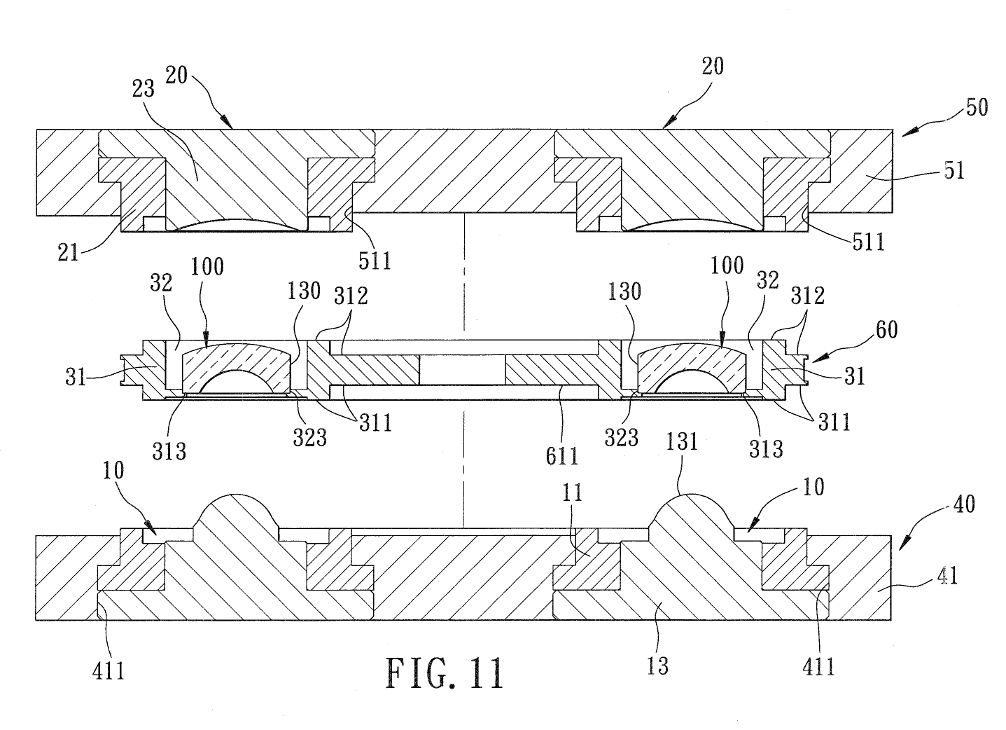

Referring to FIG. 11, there is shown a second preferred embodiment of the present invention which includes a lower mold assembly 40, an upper mold assembly 50 and a sleeve member 60.

The lower mold assembly 40 includes a lower support plate 41 having a plurality of spaced apart hollow parts 411. A plurality of lower mold units 10, specifically four mold units 10 (only two are shown), are fitted respectively in the hollow parts 411. The lower mold units 10 thus forms a unitary body.

The upper mold assembly 50 includes an upper support plate 51 having a plurality of spaced apart hollow parts 511. A plurality of upper mold units 20, specifically four mold units 20 (only two are shown), are fitted respectively in the hollow parts 511. The upper mold units 20 thus form a unitary body.

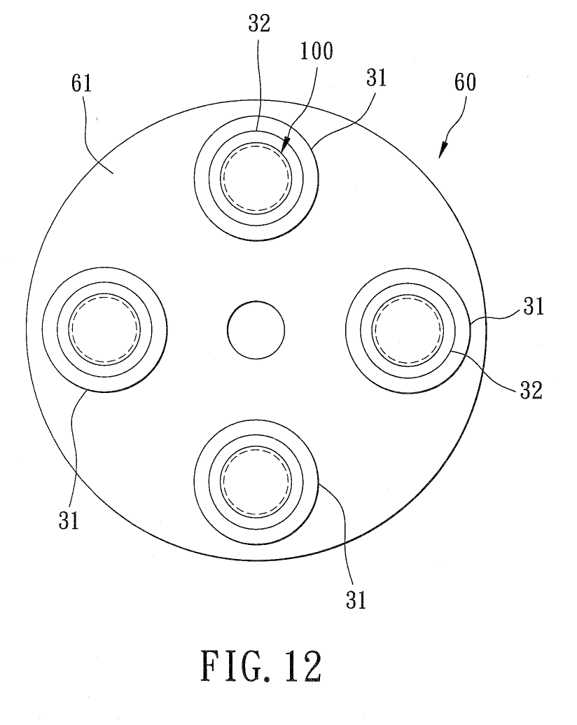

Referring to FIG. 12 in combination with FIG. 11, the sleeve member 60 includes a plurality of spaced apart sleeve walls 31, specifically four sleeve walls 31, and a connecting web 61 which is connected integrally with each sleeve wall 31. Each sleeve wall 31 is removably mountable between one of the lower mold units 10 and one of the upper mold units 20. Since the constructions and functions of the sleeve wall 31, and the upper and lower mold units 20, have been described hereinbefore, they will not be detailed hereinafter.

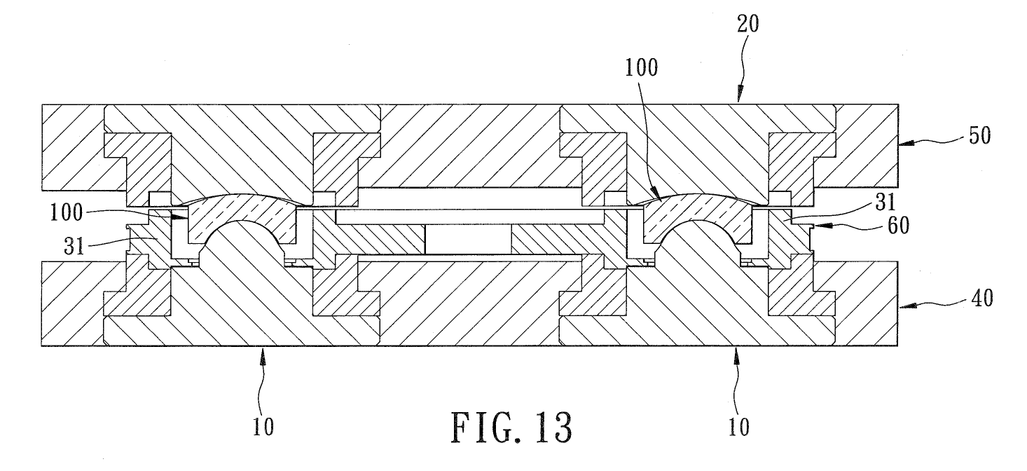

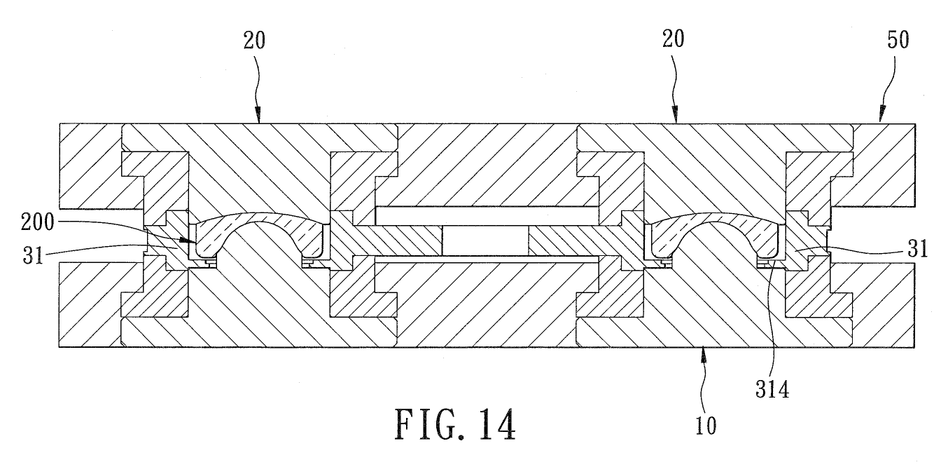

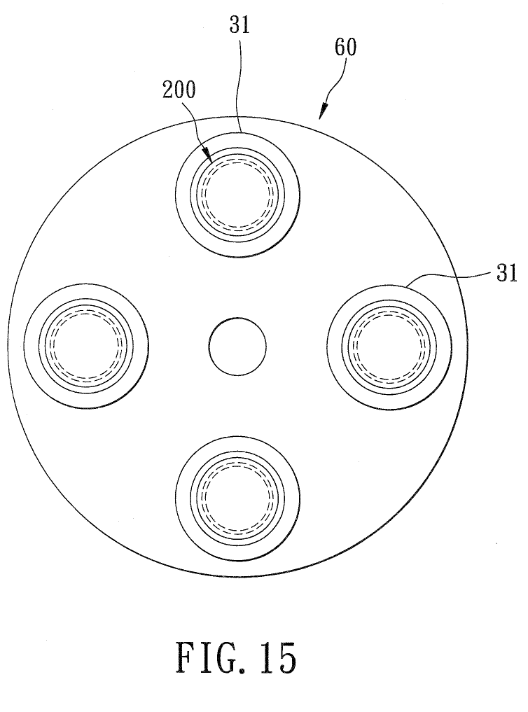

With the forming device of this embodiment, a plurality of sleeve walls 31 can be assembled with respective lower and upper mold units 10, 20 at one time, and a plurality of glass blanks 100 can be formed simultaneously within the respective sleeve walls 31, as shown in FIGS. 13-15.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

We claim:

1. A forming device for forming a glass blank into a lens, comprising:
a lower mold unit having a first forming face;
an upper mold unit including a second forming face above said first forming face; and
a sleeve member adapted to carry the glass blank and the lens, and mountable detachably between said lower and upper mold units, said sleeve member having a stepped sleeve wall confining a slot;
said slot including a first slot section, a second slot section disposed above said first slot section and having a diameter larger than that of said first slot section, a third slot section disposed above said second slot section and having a diameter larger than that of said second slot section, said second slot section having top and bottom ends connected directly to said third and first slot sections;
said stepped sleeve wall including an annular first shoulder face extending substantially radially at a junction of said first and second slot sections and adapted to contact a bottom face of the glass blank, and an annular second shoulder face adapted to support the lens, said second shoulder face being larger in diameter than said first shoulder face and extending substantially radially above said first shoulder face;
wherein a portion of said stepped sleeve wall that surrounds said second slot section extends substantially axially and perpendicularly to said first shoulder face, and is adapted to contact and limit the glass blank from movement; and
wherein, when said sleeve member is mounted between said upper and lower mold units, said first forming face extends into said slot to a height higher than said second slot section so that the glass blank is unlimited by said portion of said sleeve wall.

2. The forming device as claimed in claim 1, wherein said second shoulder face extends radially at a junction of said second and third slot sections.

3. The forming device as claimed in claim 2, wherein said lower mold unit further includes a lower socket member and a lower molding core inserted into said lower socket member, said first forming face being formed on a top end of said lower molding core, said lower socket member having a top end formed with a first abutment face to abut against said sleeve wall.

4. The forming device as claimed in claim 3, wherein said upper mold unit further includes an upper socket member, and an upper molding core inserted into said upper socket member, said upper molding core being movable relative to said upper socket member to displace away from or toward said lower molding core.

5. The forming device as claimed in claim 4, wherein said second forming face is formed on a bottom end of said upper molding core, said upper socket member having a bottom end formed with a second abutment face to abut against said sleeve wall.

6. The forming device as claimed in claim 1, which comprises a plurality of said lower mold units, and a plurality of said upper mold units, and a plurality of said sleeve members, and which further comprises a lower support plate and an upper support plate, wherein said lower mold units are spaced apart from each other and supported by said lower support plate to form a unitary body, said upper mold units being spaced apart from each other and supported by said upper support plate to form a unitary body.

7. The forming device as claimed in claim 6, wherein said lower support plate includes a plurality of spaced apart hollow parts to receive respectively said lower mold units, said upper support plate including a plurality of spaced apart hollow parts to receive respectively said upper mold units.

8. The forming device as claimed in claim 7, further comprising a connecting web, said sleeve walls of said sleeve members being spaced apart from each other and interconnected by said connecting web.
